(19) United States
(12) Patent Application Publication
(10) Pub. No.: US 2006/0072313 A1
(43) Pub. Date: Apr. 6, 2006

(54) Illumination system using multiple light emitting diodes

(75) Inventor: Simon Magarill, Cincinnati, OH (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/949,892

(22) Filed: Sep. 24, 2004

(51) Int. Cl. B60Q 1/26

(52) U.S. Cl. 362/227

(57) ABSTRACT

An illumination system is based on multiple light emitting diodes (LEDs), arranged in a row, to side-illuminate respective reflectors. The illumination system is particularly useful as a vehicle headlamp. In some embodiments, the reflectors may be curved, for example paraboloidal, to collect the light, but truncated in the direction along the row: this allows for closer packing of the LEDs. In other embodiments, the different reflectors point in different directions so as to spread the combined light beams across the driver's field of view. In other embodiments, the reflectors for the different LEDs may be formed on a single molded body.

### FIELD OF THE INVENTION

The invention relates to optical systems, and more particularly to an illumination system, for example a vehicle headlight, that uses a number of light emitting diodes as the sources of light.

### BACKGROUND

Light emitting diodes (LEDs) are devices that emit light from a semiconductor junction. The light is emitted from an LED over a wide range of angles via the combination of carriers at the junction. The large emission angle for the LED light introduces system design issues related to collecting and directing the light when the LED is used as a light source. On the other hand, the small size, long life and high optical efficiency, typically in excess of 50% of electrical energy converted to optical energy, make the LED attractive as a light source for directed illumination systems, such as vehicle headlights. There is a need, therefore, for an approach to collecting and directing LED light with high efficiency while maintaining small size and low cost.

### SUMMARY OF THE INVENTION

One exemplary embodiment of the present invention is directed to an illumination system that has at least first and second illumination modules arranged substantially side by side along a first direction, forming a first row. At least the first illumination module includes a first light emitting diode (LED) arranged to emit light generally along a first LED axis so as to illuminate a first curved reflector having a first reflector axis non-parallel to the first LED axis. The first curved reflector has a first reflecting surface that, at an output from the first illumination module, subtends an angle of less than 180° at the first reflector axis.

Another exemplary embodiment of the present invention is directed to an illumination system that has at least first and second illumination modules arranged substantially side by side along a first direction, in a first row of illumination modules. The first and second illumination modules each include a respective light emitting diode (LED) arranged to emit light generally along a respective LED axis so as to side-illuminate a respective curved reflector having a respective reflector axis non-parallel to the respective LED axis. The reflector axis of the first illumination module is non-parallel to the reflector axis of the second illumination module.

Another exemplary embodiment of the present invention is directed to a lamp unit that includes a molded transparent body defining at least first and second curved surfaces disposed sequentially along a first row in a first direction. The at least first and second curved surfaces are provided with at least first and second respectively conforming reflecting layers. The at least first and second curved surfaces define at least first and second respective reflector axes. At least first and second light emitting diodes (LEDs) are disposed to emit light generally along respective at least first and second LED axes oriented non-parallel to the first direction and non-parallel to respective reflector axes, so as to illuminate respectively the at least first and second reflective layers.

The above summary of the present invention is not intended to describe each illustrated embodiment or every implementation of the present invention. The figures and the following detailed description more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A shows a schematic perspective view of an exemplary embodiment of an illumination module according to principles of the present invention;

FIGS. 1B-1D show schematic cross-section views of an exemplary embodiment of an illumination module according to principles of the present invention;

FIG. 1E schematically illustrates a cross-sectional view of another exemplary embodiment of an illumination module according to principles of the present invention;

FIGS. 2 and 3 show schematic cross-section views of exemplary embodiments of illumination modules having curved output surfaces, according to principles of the present invention;

FIG. 4 shows a schematic cross-section view of an exemplary embodiment of an illumination module having a faceted output surface, according to principles of the present invention;

FIGS. 5A and 5B schematically illustrate exemplary embodiments of illumination systems formed from pluralities of illumination modules, according to principles of the present invention;

FIG. 5C schematically illustrates an exemplary embodiment of an illumination system formed from illumination modules with at least one non-parallel reflector axis, according to principles of the present invention;

FIG. 6A shows a schematic perspective view of an exemplary embodiment of an illumination module according to principles of the present invention;

FIG. 6B presents a graph showing the calculated depth of an illumination module as a function of output aperture size, for various values of paraboloid radius;

FIG. 6C presents a graph showing the calculated collection efficiency of an illumination module as a function of output aperture size, for various values of paraboloid radius;

FIGS. 7A and 7B schematically illustrate exemplary embodiments of illumination systems formed using sub-units of illumination modules, according to principles of the present invention;

FIG. 8A schematically illustrates an exemplary embodiment of an illumination module used in the description of Example 1;

FIG. 8B schematically illustrates a sub-unit formed using illumination modules as shown in FIG. 8A and used in the description of Example 1;

FIGS. 8C-8E present calculated illumination patterns produced by the sub-unit illustrated in FIG. 8B;

FIG. 9A schematically illustrates an exemplary embodiment of an illumination module used in the description of Example 2;

FIG. 9B schematically illustrates a sub-unit formed using illumination modules as shown in FIG. 9A and used in the description of Example 2; and

FIG. 9C presents a calculated illumination pattern produced by the sub-unit illustrated in FIG. 9B.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is more particularly applicable to light collection and management systems useful for illuminating a target with light from one or more light emitting diodes (LEDs).

LEDs with higher output power are becoming more available, which opens up new applications for LED illumination. Some applications that may be addressed with high power LEDs include their use as light sources in projection and display systems, as illumination sources in machine vision systems and camera/video applications, and also in distance illumination systems such as vehicle headlights.

LEDs typically emit light over a wide angle, and one of the challenges for the optical designer is to efficiently collect the light produced by an LED and direct the light to a selected target area and/or within a selected angular aperture. Another challenge is to package the LEDs effectively, that is to reduce the footprint of the LED assembly while maintaining the desired optical characteristics.

In the following description, the term LED is used to refer to a light emitting diode that may or may not be closely coupled with a lens. The light emitting diode may be simply an LED die, or may include some other configuration, for example an LED die encapsulated within a lens.

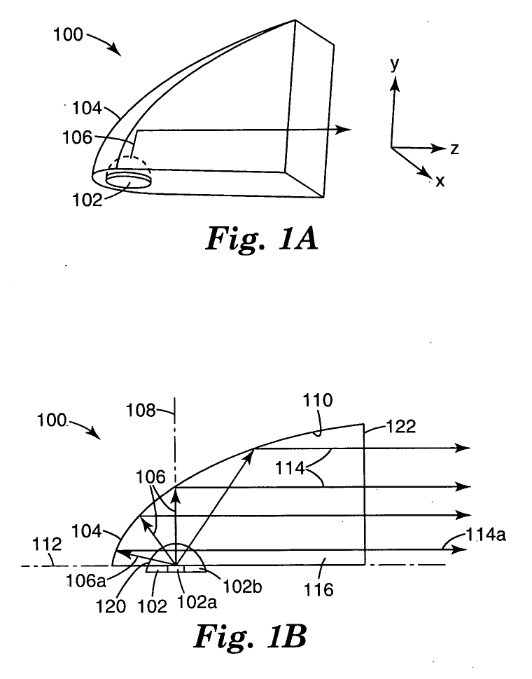

One approach to collecting and directing the light emitted by an LED is discussed with respect to the exemplary embodiment of illumination module 100 schematically illustrated in FIGS. 1A-1D. FIG. 1A shows a perspective view of the illumination module 100, in which an LED 102 directs light 106 towards a reflector 104.

FIGS. 1B-1D show various cross-sectional views through the illumination module 100 as indicated by the x-y-z axes. In this exemplary embodiment, the LED 102 is formed of an LED die 102a encapsulated within a lens 102b. The LED 102 has an associated LED axis 108, and the light 106 emitted from the LED 102 is generally symmetrical about the axis 108. Where the pattern of light 106 is not symmetrical about the LED axis 108, the LED axis 108 corresponds to the average direction along which light 106 is emitted from the LED 102.

The reflector 104 has a reflecting surface 110 that is curved and has a reflector axis 112. The reflecting surface 110 may conform to a surface of revolution about the reflector axis 112. The reflecting surface 110 may, for example, conform to a paraboloidal surface, or to some other type of surface of revolution. The light 106 may be emitted from an area of the LED 102 positioned close to, or at, a focus of the reflecting surface 110, on the reflector axis 112. It should be understood that, when a reflecting surface is described in the present description as conforming to a surface of revolution, there is no implication that the reflecting surface must comprise an entire revolution.

The divergence of the light 114 reflected by the curved reflecting surface 110 is different from the divergence of the incident light 106 and light 114 may be at least partially collimated. In one exemplary embodiment, in which the LED 102 is placed close to the focus of a paraboloidal reflecting surface 110, the light 114 may be substantially collimated.

The LED axis 108 is typically not parallel to the reflector axis 112, and may be perpendicular to the reflector axis 112. In this configuration, where the LED axis 108 is not parallel to the reflector axis 112, the LED 102 may be said to side-illuminate the reflector 104. The reflecting surface 110 may be formed of any suitable reflective material for reflecting light at the wavelength of light emitted by the LED 102. The reflecting surface 110 may be, for example, formed by multiple polymer layers whose thicknesses are selected to provide a desired degree of reflectivity. In other examples, the reflecting surface 110 may be metalized, or may be coated with a stack of inorganic dielectric coatings.

In some exemplary embodiments, the reflector 104 may include a transparent body 116 disposed between the LED 102 and the reflecting surface 110. The transparent body 116 may be formed from any suitable transparent material, for example, from a polymer such as polycarbonate, cyclic olefin copolymers (COC), such as copolymers of ethylene and norbornene, polymethyl methacrylate (PMMA), or the like. The transparent body 116 may be molded into shape or formed using some other method. The reflecting surface 110 may be formed over an outside surface of the transparent body 116. Light 106 from the LED 102 is reflected at the reflecting surface 110 and the reflected light 114 passes through an output surface 122 of the illumination module 100.

In other exemplary embodiments, the reflector 104 may be formed with the reflecting surface 110 disposed on the inner surface of a curved substrate so that the reflecting surface 110 lies between the substrate and the LED 102. Such a reflector may be referred to as a hollow reflector.

Where the reflector 104 includes a transparent body 116, the transparent body 116 may be provided with a concave surface 120 concentric to the location of the LED emitting area 102a and the LED lens 102b may be secured in this concave surface, for example using optical cement. This arrangement is convenient because the interface between the lens 102b and the transparent body 116 may then be at least partially index matched, thus reducing refractive effects and reducing reflective losses.

A reflector 104 that includes a transparent body 116 operates differently from one that does not include a transparent body 116. One difference is described with reference to light ray 106a (see FIG. 1B), emitted from the LED 102 in a direction close to being parallel with the reflector axis 112. Light ray 106a is reflected by the reflecting surface 110 as light ray 114a. When the lens 102b is at least partially index-matched to the transparent body 116, the light ray 114a may pass through the lens 102b to the output surface 122 of the body 116 with relatively little or no deviation. When there is little or no index matching to the lens 102b, for example when the reflector is hollow, the lens 102b may refract reflected ray 114a into a direction away from the desired direction. Accordingly, there may be an increase in the amount of light reaching the target area when a reflector having a transparent body 116 is used.

Another difference between a solid body reflector and a hollow reflector is that the output surface 122 of the transparent body 116 may provide a refracting surface used to control the direction of the reflected light 114. This gives the designer another degree of freedom to control the direction of the light exiting from the illumination module 100. In the exemplary embodiment of illumination unit 100 illustrated in FIG. 1B, the surface 122 is flat and is substantially perpendicular to the reflector axis 112. It will be appreciated that a flat output surface 122 need not be perpendicular to the reflector axis 112 and that the angle between the output surface 122 and the reflector axis 112 may have some angle other than 90°.

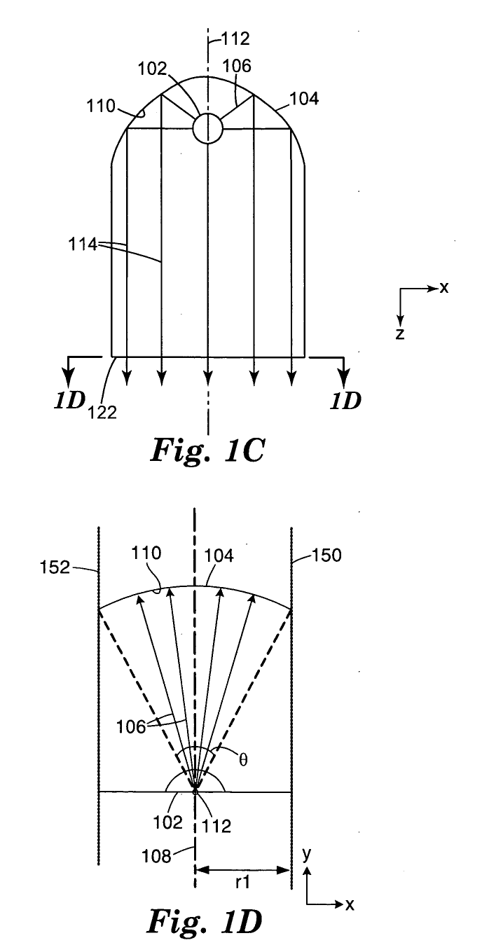

Additionally, the output surface need not be flat. The output surface 222 may be curved, for example as illustrated in FIG. 2. The curved output surface 222 acts as a lens and, in an exemplary embodiment, may act as a positive lens so as to add focusing power to the focusing power of the reflecting surface 110, thus focusing the light 214 exiting from the illumination unit. In another exemplary embodiment, the curved output surface 222 may act as a negative lens so as to subtract focusing power from the focusing power of the reflecting surface 110. It will be appreciated that the curved output surface 222 need not be curved over its entire area, and that the output surface 222 may have a portion that is flat and a portion that is curved. Furthermore, different portions of the output surface 222 may be provided with different curves so that the different portions of the output surface have different focusing powers.

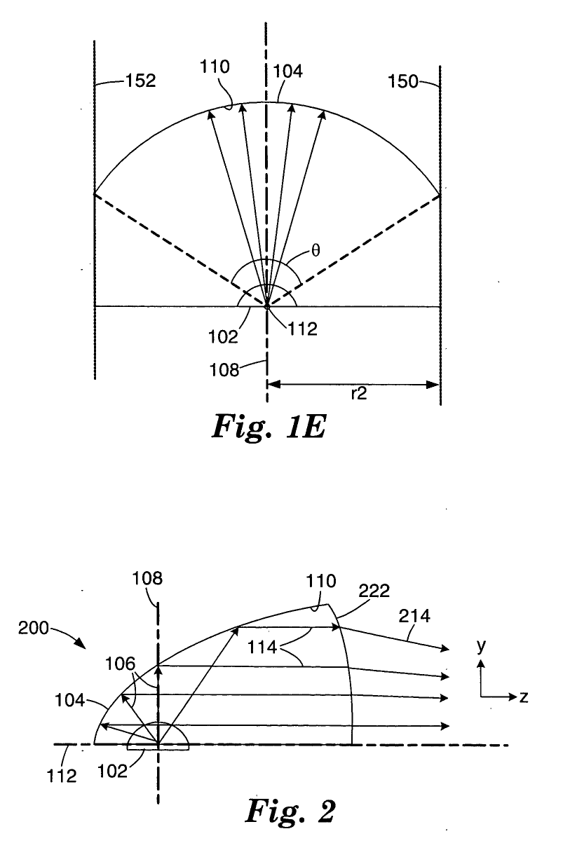

In the exemplary embodiment illustrated in FIG. 2, the output surface is curved with a radius of curvature lying in the y-z plane. In another exemplary embodiment, the output surface 322 may be curved with its radius of curvature lying in the x-z plane, for example as schematically illustrated in FIG. 3, so that the light 314 exiting the illumination module 300 is focused in the x-z plane. The output surface 222, 322 may be cylindrically curved or may be spherically or aspherically curved.

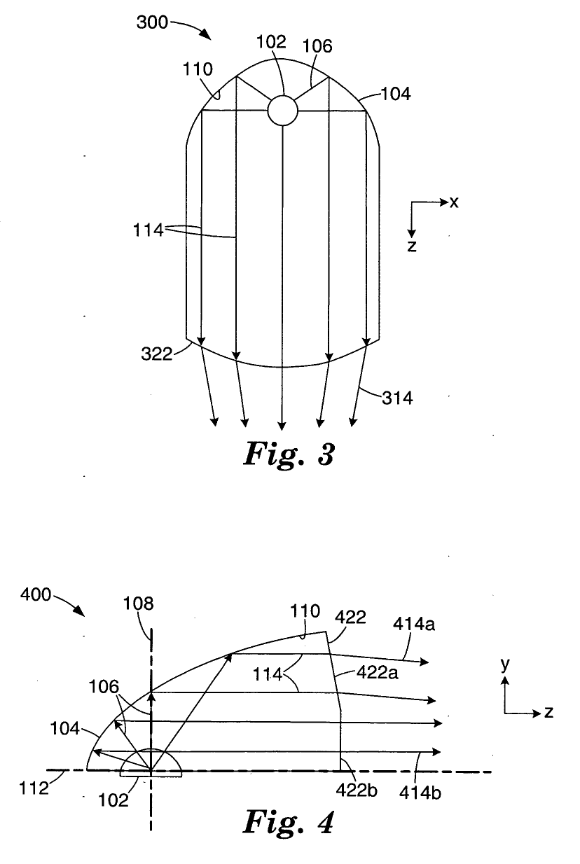

The output surface 422 may be faceted, for example as illustrated in FIG. 4. The faceted output surface 422 may include two or more facets 422a and 422b so as to refract different reflected rays 414a and 414b in different directions.

In some exemplary embodiments, the reflector 104 is truncated in the x-direction, and so the reflecting surface 110 may subtend an angle of less than 180° at the reflector axis 112 at the output of the reflector unit 104. This is described in more detail with reference to FIG. 1D which shows a cross-section of the illumination module 100 looking along the reflector axis 112. FIG. 1C shows the plane of the view in FIG. 1D as the section 1D-1D. The angle subtended by the reflecting surface 110 at the reflector axis 112 is shown as angle θ. Section 1D-1D is at the output end of the illumination module 100, and so the angle θ is the angle subtended by the reflecting surface 110, at the output of the illumination module 100, at the reflector axis 112. The value of θ depends on the extent by which the reflecting surface 110 is truncated in the x-direction. The truncation surfaces 150 and 152 represent the lateral extent (in the +x and −x direction) of the reflector 104, and need not represent physical surfaces in a module. The value of θ increases as the truncation surfaces 150 and 152 are made more distant from the reflector axis 112, at least up to a value of 180°. In the exemplary embodiment illustrated in FIG. 1E, the value of θ is higher than that for the embodiment illustrated in FIG. 1D, since r2 is greater than r1. In some exemplary embodiments, the value of θ is less than 180°, and may be less than 120°, 90°, or 60°.

In some exemplary embodiments, the truncation surfaces 150 and 152 may be planar and may be parallel to each other. In other exemplary embodiments, the truncation surfaces 150 and 152 may not be parallel to each other, or may not be planar. In addition, in some exemplary embodiments, the truncation surfaces 150 and 152 may be, but are not required to be, parallel to a plane defined by the reflector axis 112 and the LED axis 108, i.e. the y-z plane in the notation of FIGS. 1A-1E.

A number of illumination modules may be packaged together to form an illumination system. One design criterion that is often important when packaging a number of light sources together is to reduce the overall size of the multi-source package while maintaining high efficiency of illumination into a particular angular aperture. An illumination system that includes a number of illumination modules provides some flexibility in reducing the package size while efficiently directing light into a desired angular aperture. Furthermore, the integration of multiple illumination modules into a single body reduces the part count, thus reducing part and assembly costs.

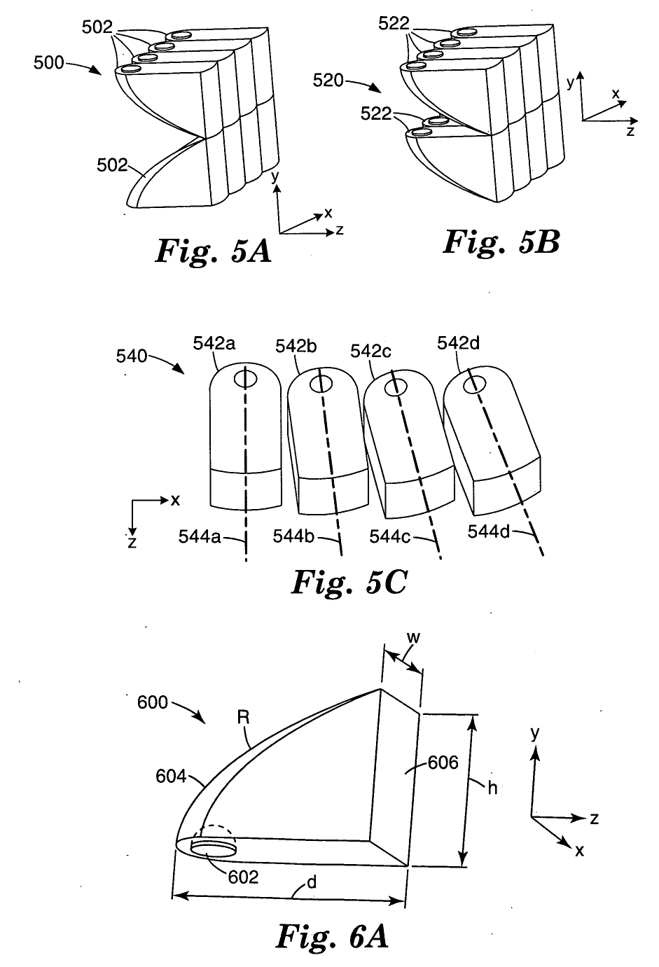

FIG. 5A schematically illustrates an exemplary embodiment of an illumination system 500 that has two rows, each row having four illumination modules 502. The output from the illumination system 500, therefore, combines the output from each of the eight illumination modules 502. In this exemplary embodiment, the modules 502 in the upper row are oriented differently from the modules 502 in the lower row. In some configurations this may provide for easier access to the LEDs for maintenance. In another exemplary embodiment, schematically illustrated in FIG. 5B, an illumination system 520 comprises modules 522 in two rows with the same orientation. It will be appreciated that an illumination system may have a different number of illumination modules in a row, and may also have a different number of rows of illumination modules.

In the exemplary embodiments of illumination system 500 and 520, the illumination modules 502 and 522 are shown with cylindrically curved output surfaces, thereby spreading the light in the x-z plane. Another approach to increasing the spread of light in the x-z plane is to arrange the illumination modules so that their respective reflector axes are not parallel. One particular example of this is schematically illustrated in FIG. 5C, which shows an illumination system 540 having four illumination modules 542a-542d, along with their respective reflector axes 544a-544d. The reflector axes 544a-544d are not parallel, and so the light is spread in the x-z plane. For example, if the light from a single illumination module has a divergence of 10°, and all four illumination modules are aligned with parallel reflector axes, then the divergence of the combined output from all the illumination modules is approximately 10°. On the other hand, if the reflector axes are not parallel, then the divergence of the combined output beam may be greater than 10°.

It will be appreciated that not all the reflector axes 544a-544d need be non-parallel to the others, and that some of the reflector axes 544a-544d may be parallel to each other.

In some exemplary embodiments, for example those schematically illustrated in FIGS. 5A-5C, the illumination systems may be manufactured with the modules molded together as a single unit or sub-unit. For example, a single body may be molded with the transparent bodies of a number of illumination modules. The reflecting surfaces may then be formed by providing a mirror coating, a reflecting coating, or a reflecting film on certain surfaces of the molded body.

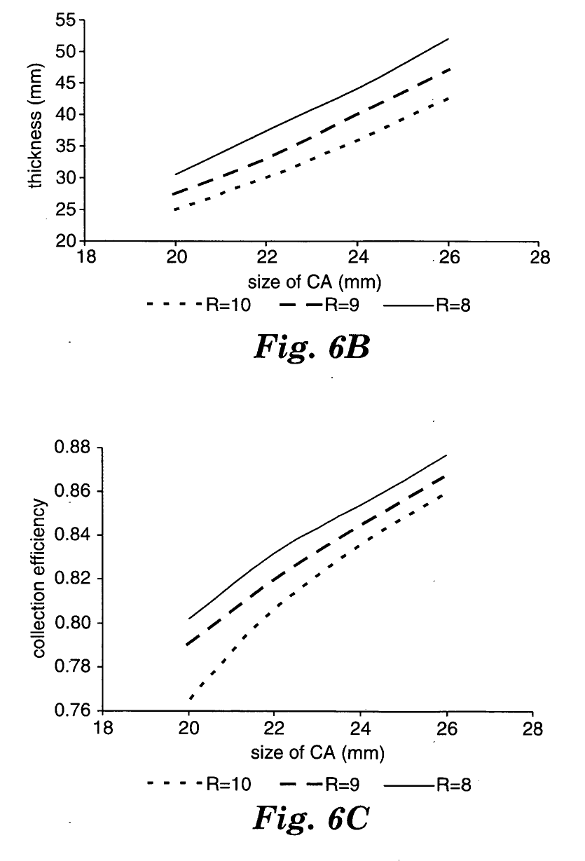

Various dimensions of an illumination module are defined in FIG. 6A. The illumination module 600 has an LED 602 that illuminates a reflector 604. Light from the reflector 604 exits through the output 606 of the illumination module 600. The output 606 corresponds to an output surface of the reflector 604 or, where the reflector 604 is a hollow reflector, a plane perpendicular to the reflector axis that intersects the portion of the reflecting surface farthest from the LED. The depth, d, of the illumination module 600 is defined as the distance from the apex of the reflector 604 to the output 606, in the z-direction. The width, w, of the module 600 is the width of the output 606 in the x-direction and the height, h, is the height of the module 600 at the output 606 in the y-direction. The reflector 604 is assumed to be a paraboloidal reflector with a radius R, where R is the inverse of the curvature, c, i.e. R=1/c, and the parabola that is rotated about the z-axis to form the paraboloid is defined in terms of c in the following expression:
z=(cy²)/(1+(1−(1+k)c²y²)^{1/2}).
In this expression, y is the value of the surface co-ordinate along the y-axis, and k is the conic constant. For a paraboloid, the value of k is −1, so the expression simplifies to z=(cy²)/2.

The optical characteristics of such a module can be numerically modeled. The results of some such calculations are illustrated in the graphs shown in FIGS. 6B and 6C. FIG. 6B shows the depth, d, in mm, as a function of the size of the output: the output was assumed to be square, in which case w=h. Thus, the dimension CA (clear aperture) is equal to both w and h. The calculation was performed for paraboloidal surfaces having three different values of R, viz. 8 mm, 9 mm and 10 mm. The results of the calculation show that the depth of the module increases with the size of the aperture. Also, for a given aperture size, the depth is greater for a smaller value of R.

FIG. 6C shows the geometrical collection efficiency as a function of the aperture size, CA, for the three different values of R. The geometrical collection efficiency is the fraction of light emitted from the LED that exits through the output aperture of the illumination module and within a specified angular aperture. For the graph shown in FIG. 6C, the angular aperture was assumed to be ±5° in the vertical direction (in the y-direction) and ±35° in the horizontal direction (x-direction). The collection efficiency was calculated strictly as a geometrical parameter, and did not take into account Fresnel reflection, absorption or any other losses. The collection efficiency depends on the size and shape of the reflector. The collection efficiency increases with increased size of the output aperture, and also increases with smaller values of R.

For a square aperture, the angle, θ, subtended by the reflecting surface at the reflector axis is about 53.2°, and thus it can be seen that the collection efficiency of the illumination module can be high even when significant truncation takes place. If the value of θ is 180° or higher, then the width of the illumination module is maximized, and so limits the density with which the modules can be packed. The calculations illustrated in FIG. 6C shows that the illumination modules can be truncated, which permits closer module packing, without significant reduction in the geometric collection efficiency. This results in a higher output of light per unit area from the illumination system than would otherwise be possible where the value of θ is 180° or greater.

An illumination system that uses illumination modules as disclosed herein may employ a number of identical illumination modules or may employ illumination modules having different characteristics of, for example, brightness and divergence. Some exemplary embodiments of an illumination system may employ a number of a first type of illumination modules, having a first set of illumination characteristics, and a number of a second type of illumination modules, having a second set of illumination characteristics.

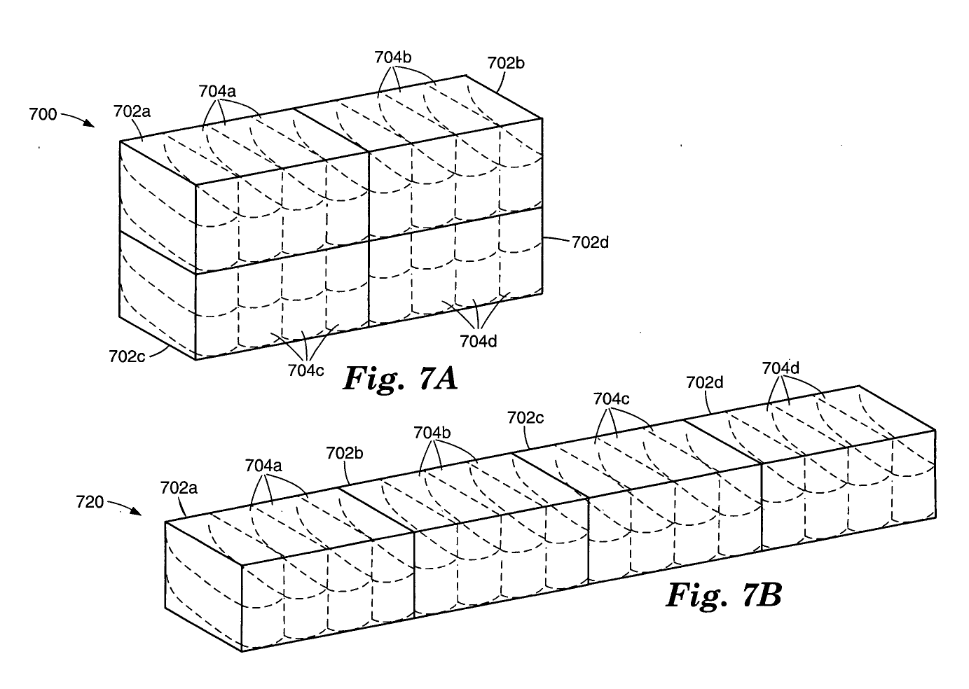

One particular exemplary embodiment of an illumination system 700, schematically illustrated in FIG. 7A, employs four sub-units 702a-702d. Each sub-unit 702a-702d contains a number of respective illumination modules 704a-704d. Each type of illumination module 704a-704d may have its own individual illumination characteristics. In the illustrated exemplary embodiment, each sub-unit 702a-702d includes two rows of illumination modules 704a-704d, and four illumination modules 704a-704d in each row. It will be appreciated that each sub-unit 702a-702d may have a different number of respective illumination modules in each row, and/or a different number of rows. Furthermore, in the illustrated exemplary embodiment, the sub-units 702a-702d are stacked to form two rows, each row having two sub-units. The sub-units 702a-702d may be arranged differently, for example, arranged in a single row as schematically illustrated for the illumination system 720 in FIG. 7B. Furthermore, the illumination system may include a different number of sub-units, may stack a different number of sub-units in a row, and/or have a different number of rows.

Arrangements of illumination modules, such as those shown in FIG. 7A or 7B may find use in lighting applications, for example, automobile headlights. Some considerations for LED-based automobile headlights suggest the use of a number of different overlapping illumination beams in a headlight to achieve a desirable overall illumination effect. The different beams are typically obtained from different sub-units containing multiple illumination modules. In one particular exemplary embodiment, a headlight has four different sub-units that produce four different illumination beams, whose characteristics are summarized in Table I.

TABLE I
Summary of Beam Characteristics for Sample Headlight

| Beam No. | vertical div. | horizontal div. | brightness (L) |
|---|---|---|---|
| 1 | ±2° | ±5° | 300 |
| 2 | ±5° | ±35° | 800 |
| 3 | ±3° | ±12° | 800 |
| 4 | ±5° | ±50° | 400 |

For each beam listed in Table I, values are provided for the full-width, half-maximum (FWHM) vertical and horizontal divergences, and the beam brightness in lumens. Beam 1 is a bright spot beam, with a relatively small divergence, that illuminates the center field of view. Beam 2 is a wide angle, bright beam, while Beam 3 is a mid-divergence, bright beam. Beam 4 gives wide angle, relatively near-field coverage, and is particularly useful when the vehicle is turning a corner. Not all the illumination modules of beam 4 need be used simultaneously. For example, those illumination modules that point to the left may be operated when the vehicle turns to the left and those modules that point to the right may be used when the vehicle turns to the right. Furthermore, the angle through which the vehicle is turned may control which particular illumination modules are operated. In some exemplary embodiments, some or all of the illumination modules in the sub-unit may be physically turned in the direction in which the vehicle is turning. The following two examples illustrate details for the sub-units used for producing beams 1 and 2. In both examples, the LED used in the illumination modules was assumed to be a Luxeon LXHL-PW09 type white-light emitting LED, produced by Lumileds Lighting LLC, San Jose, Calif. This LED produces 80 lumens of white light, having a Lambertian radiation pattern, from an emitting surface 0.95 mm×0.95 mm.

### EXAMPLE 1

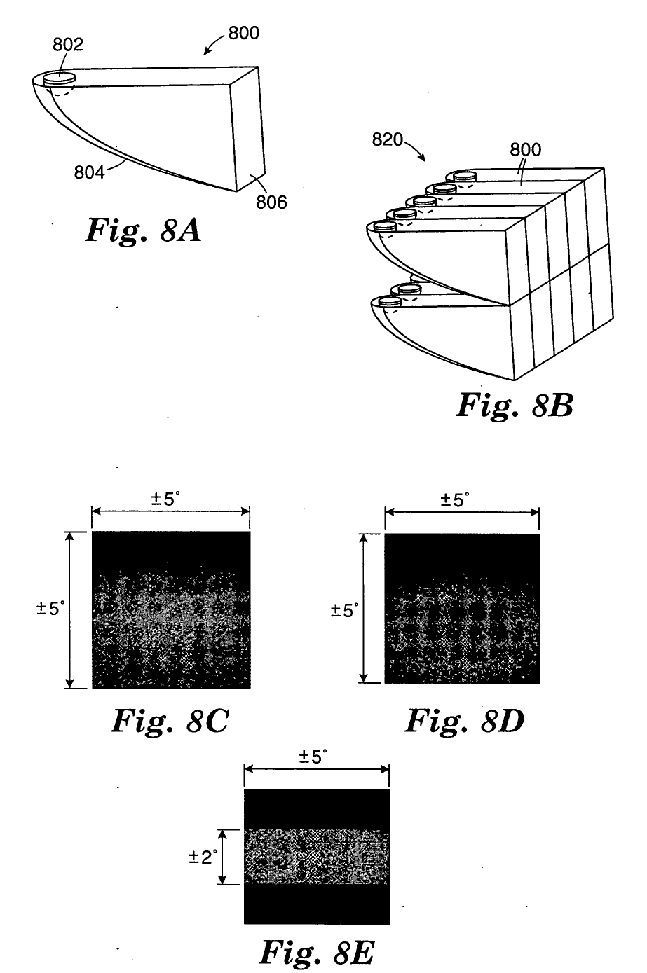

An exemplary embodiment of an illumination module 800 used in a sub-unit to generate beam 1 is schematically illustrated in FIG. 8A. The module 800 includes an LED 802, a paraboloidal reflector 804, and an output surface 806. The paraboloidal reflector 804 has a value of R=10 mm, a depth, d=36 mm and the output surface is square with a height and width, h and w, equal to 24 mm. The output surface 806 of the module 800 is flat. The desired angular aperture from the sub-unit is ±2° vertically and ±5° horizontally. Accordingly, the amount of light, P, generated by a single illumination module into this angular aperture can be calculated as:
P=Pₒ×CE×L1×L2 (1)
where P₀ is the amount of light output from the LED, CE is the geometrical light collection efficiency, L1 is reflectivity of the reflector and L2 is the transmission through the output surface of the module. The value of CE, for this particular angular aperture can be calculated to be 42.1%. The value of L1, the reflectivity of the reflector is assumed to be 0.99. If the output surface of the module is uncoated, then there is a Fresnel reflection loss at the output surface, and so L2 is assumed to be 0.96. Thus, the value of P for a single illumination module may be calculated using equation (1) to be 32 Lumens. Thus, a sub-unit 820, schematically illustrated in FIG. 8B, having 10 such modules 800, produces an output of 320 Lumens into the desired angular aperture. This satisfies the requirements for beam 1.

The calculated output from the sub-unit 820 is presented in FIG. 8C, which shows the output over an angular aperture of ±5° by ±5°. In the particular example described here, the LEDs were assumed to be displaced from the focus of their respective paraboloidal reflectors by 200 μm towards the apex of the paraboloid. This displacement has the effect of reducing the amount of light that is directed in the upward direction, hence the upper portion of FIG. 8C is relatively dark. This effect may be useful in vehicle headlight systems, since the light is directed less into the sky and more towards the road. The effect is even more pronounced when the LEDs were assumed to be displaced 400 μm from the focus towards the apex of the paraboloid, as shown in FIG. 8D. FIG. 8E shows the calculated illumination into an angular aperture of ±2° by ±5°, where the LEDs were assumed to be displaced from the respective foci by 400 μm.

### EXAMPLE 2

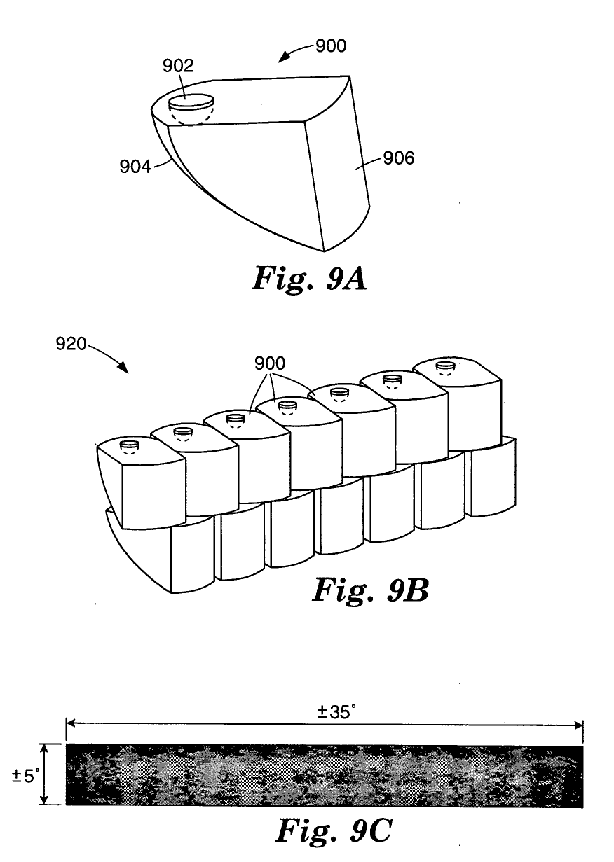

An exemplary embodiment of an illumination module 900 used in a sub-unit to generate beam 2 is schematically illustrated in FIG. 9A. The module 900 includes an LED 902, a paraboloidal reflector 904, and an output surface 906. The paraboloidal reflector 904 has a value of R=9 mm, a depth of d=30.5 mm. The output surface 906 is square with a height and width, h and w, equal to 20 mm. The output surface 906 of the module 900 has a cylindrical surface with a radius of curvature equal to 19 mm. The use of a curved output surface 906 may increase the spread of light in the horizontal direction. The desired angular aperture from the sub-unit is ±5° vertically and ±35° horizontally. The geometrical collection efficiency, CE, into this angular aperture can be obtained from FIG. 6C as about 79%. The amount of light, P, generated by a single illumination module into this angular aperture can be calculated using expression (1) as 60.1 Lumens, where the values of L1 and L2 are as given in Example 1. Therefore, a sub-unit 920 with fourteen such illumination modules 900 can be calculated to provide 841.4 Lumens, which meets the output power requirements for beam 2.

The horizontal divergence from a single illumination module 900 may be less than ±35°, however, so the modules 900 in the sub-unit 920 may be arranged with non-parallel reflector axes so as to provide a broader horizontal spread of light.

The calculated output from the sub-unit 920 is presented in FIG. 9C, which shows the output over an angular aperture of ±35° by ±5°.

Other sub-units for producing beams 3 and 4 may be designed in a manner similar to the design used for sub-units 820 and 920. It will be appreciated that the designs described in Examples 1 and 2 are illustrative only, and that other factors not discussed here may also affect the output power and divergence of the light from a sub-unit.

Although the present description has concentrated mostly on the use of paraboloidal reflecting surfaces, there is no restriction to using only these types of surfaces, and other types of surfaces may also be used. Furthermore, reflectors formed from these different surfaces may be hollow reflectors or may be solid reflectors.

Accordingly, the present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. An illumination system, comprising:
at least first and second illumination modules arranged substantially side by side along a first direction, forming a first row, the first illumination module comprising a first light emitting diode (LED) arranged to emit light generally along a first LED axis so as to illuminate a first curved reflector having a first reflector axis non-parallel to the first LED axis, the first curved reflector comprising a first reflecting surface that subtends an angle of less than 180° at the first reflector axis at an output from the first illumination module.

2. A system as recited in claim 1, wherein the second illumination module has a second reflecting surface and a second reflector axis, the first and second reflector axes being adjacently positioned closer together than would be possible if the first reflecting surface, at the output from the first illumination module, subtended an angle of at least 180° at the first reflector axis.

3. A system as recited in claim 1, wherein the second illumination module comprises a second curved reflector having a second reflecting surface and a second reflector axis, and a second LED arranged to emit light generally along a second LED axis so as to illuminate the second curved reflector.

4. A system as recited in claim 3, wherein the second reflecting surface subtends an angle of less than 180° at the second reflector axis at an output from the second illumination module.

5. A system as recited in claim 3, further comprising at least a third illumination module arranged in the row with the first and second illumination modules.

6. A system as recited in claim 3, wherein at least one of the first and second curved reflectors comprises a hollow curved reflector.

7. A system as recited in claim 1, wherein the first curved reflector comprises a transparent body disposed between the first LED and the first reflecting surface.

8. A system as recited in claim 7, wherein the first LED is mounted to the transparent body.

9. A system as recited in claim 8, wherein the first LED comprises a lens, the transparent body comprises a concave region, and the lens is mated to the concave region of the transparent body.

10. A system as recited in claim 7, wherein the transparent body has a flat output face.

11. A system as recited in claim 7, wherein the transparent body has a curved output face.

12. A system as recited in claim 7, wherein the transparent body has a facetted output face.

13. A system as recited in claim 1, wherein the first LED is positioned approximately at a focus of the first reflecting surface.

14. A system as recited in claim 1, wherein the first LED is positioned approximately on the first reflector axis and between a focus of the first reflecting surface and an apex of the first reflecting surface.

15. A system as recited in claim 1, wherein the first reflecting surface subtends an angle of less than 120° at the first reflector axis at the output from the first illumination module.

16. A system as recited in claim 15, wherein the first reflecting surface subtends an angle of less than 90° at the first reflector axis at the output from the first illumination module.

17. A system as recited in claim 16, wherein the first reflecting surface subtends an angle of less than 60° at the first reflector axis at the output from the first illumination module.

18. A system as recited in claim 1, wherein the first reflecting surface conforms to a curved reflective surface that is truncated by a first truncating surface that is displaced along the first direction from the first reflector axis.

19. A system as recited in claim 18, wherein the first truncating surface is substantially parallel to a plane defined by the first LED axis and the first reflector axis.

20. A system as recited in claim 18, wherein the first reflecting surface is truncated by a second truncating surface, the first reflector axis being displaced along the first direction from the second truncating surface.

21. A system as recited in claim 1, wherein the second illumination module comprises a second curved reflector having a second reflector axis, the first and second reflector axes being substantially parallel.

22. A system as recited in claim 1, wherein the second illumination module comprises a second curved reflector having a second reflector axis, the first and second reflector axes being substantially non-parallel.

23. A system as recited in claim 1, further comprising a second row of at least two illumination modules, the second row being displaced from the first row along a direction substantially parallel to the first LED axis of the first illumination module.

24. A system as recited in claim 1, wherein the first reflecting surface defines part of a paraboloid.

25. An illumination system, comprising at least first and second illumination modules arranged substantially side by side along a first direction, in a first row of illumination modules, the first and second illumination modules each comprising a respective light emitting diode (LED) arranged to emit light generally along a respective LED axis so as to side-illuminate a respective curved reflector having a respective reflector axis non-parallel to the respective LED axis, the reflector axis of the first illumination module being non-parallel to the reflector axis of the second illumination module.

26. A system as recited in claim 25, further comprising at least a third illumination module having a third reflector axis parallel to one of the reflector axes of the first and second illumination modules.

27. A system as recited in claim 25, further comprising a second row of illumination modules comprising at least third and fourth illumination modules, the second row being displaced from the first row along a direction substantially parallel to at least one of the LED axes of the first and second illumination modules.

28. A system unit as recited in claim 25, wherein at least one of the first and second illumination modules comprises a hollow curved reflector.

29. A system as recited in claim 25, wherein at least one of the first and second illumination modules comprises a respective curved reflector that comprises a transparent body disposed between a respective LED and a respective reflective surface.

30. A system as recited in claim 29, wherein the transparent body has a flat output face.

31. A system as recited in claim 29, wherein the transparent body has a curved output face.

32. A system as recited in claim 29, wherein the transparent body has a facetted output face.

33. A system as recited in claim 29, wherein the respective LED is mounted to the transparent body.

34. A system as recited in claim 33, wherein the respective LED comprises a lens, the transparent body comprises a concave region, and the lens is mated to the concave region of the transparent body.

35. A system as recited in claim 25, wherein at least one of the first and second illumination units comprises a reflecting surface that defines part of a paraboloid.

36. A system as recited in claim 25, wherein, in at least one of the first and second illumination modules, the respective LED is positioned approximately at a focus of the reflecting surface.

37. A system as recited in claim 25, wherein, in at least one of the first and second illumination modules, the respective LED is positioned between a focus of a respective reflecting surface and an apex of the respective reflecting surface.

38. A system as recited in claim 25, wherein at least one of the first and second illumination modules has a curved reflector that comprises a reflective surface, the reflective surface subtending, at an output from the at least one of the first and second illumination modules, an angle, θ, of less than 180° at the respective reflector axis.

39. A system as recited in claim 38, wherein the reflective surface conforms to a curved reflective surface that is truncated by a first truncating surface that is positioned along the first direction from the respective reflector axis.

40. A system as recited in claim 39, wherein the truncating surface is substantially parallel to a plane defined by the respective LED axis and the respective reflector axis.

41. A system as recited in claim 39, wherein the reflective surface is truncated by a second truncating surface, the respective reflector axis being positioned along the first direction from the second truncating surface.

42. A system as recited in claim 38, wherein reflector axes of the first and second illumination modules are positioned closer together than would be possible if first and second illumination modules each had respective reflective surfaces that, at the outputs from the first and second illumination modules, each subtended an angle of at least 180° at the respective reflector axes.

43. A system as recited in claim 38, wherein the angle, θ is less than 120°.

44. A system as recited in claim 43, wherein the angle, θ is less than 90°.

45. A system as recited in claim 44, wherein the angle, θ is less than 60°.

46. A lamp unit, comprising:
a molded transparent body defining at least first and second curved surfaces disposed sequentially along a first row in a first direction, the at least first and second curved surfaces being provided with at least first and second respectively conforming reflecting layers, the at least first and second curved surfaces defining at least first and second respective reflector axes; and
at least first and second light emitting diodes (LEDs) disposed to emit light generally along respective at least first and second LED axes oriented non-parallel to the first direction and non-parallel to respective reflector axes, so as to illuminate respectively the at least first and second reflective layers.

47. A unit as recited in claim 46, wherein the first and second reflector axes are non-parallel.

48. A unit as recited in claim 46, wherein the molded transparent body further defines at least third and fourth curved surfaces disposed along a second row in the first direction, the at least third and fourth curved surfaces being provided with at least third and fourth respectively conforming reflecting layers, the at least third and fourth curved surfaces defining at least third and fourth respective reflector axes, and further comprising at least third and fourth respective LEDs disposed to illuminate respectively the at least third and fourth reflecting layers.

49. A unit as recited in claim 46, wherein the first and second LEDs are mounted to the transparent body.

50. A unit as recited in claim 49, wherein the first LED comprises a lens, the transparent body comprises a concave mounting region, and the lens of the first LED is mated to the concave mounting region of the transparent body.

51. A unit as recited in claim 46, wherein the transparent body defines at least first and second respective output faces, light from respective LEDs being reflected by the respective reflecting layers and exiting the transparent body through the respective output faces.

52. A unit as recited in claim 51, wherein at least one of the output faces is curved.

53. A unit as recited in claim 51, wherein at least one of the output faces is facetted.

54. A unit as recited in claim 51, wherein at least one of the output faces is flat.

55. A unit as recited in claim 46, wherein at least one of the first and second curved surfaces is paraboloidal.

56. A unit as recited in claim 55, wherein at least one of the first and second LEDs is respectively positioned approximately at a focus of the at least one of the first and second paraboloidal curved surfaces.

57. A unit as recited in claim 55, wherein at least one of the first and second LEDs is respectively positioned between a focus of a respective paraboloidal curved surface and an apex of the respective paraboloidal curved surface.

58. A unit as recited in claim 46, wherein at least one of the first and second reflecting layers subtends an angle, θ, of less than 180° at the respective reflector axis, at a respective output from the transparent body.

59. A system as recited in claim 58, wherein the angle, θ is less than 120°.

60. A system as recited in claim 59, wherein the angle, θ is less than 90°.

61. A system as recited in claim 60, wherein the angle, θ is less than 60°.
